(19) United States
(12) Patent Application Publication
(10) Pub. No.: US 2022/0314792 A1
(43) Pub. Date: Oct. 6, 2022

(54) VEHICLE SPEED LIMITING

(71) Applicant: Ford Global Technologies, LLC, Dearborn, MI (US)

(72) Inventors: Jennifer Flake, Dearborn, MI (US); Keith Weston, Canton, MI (US); Brendan F. Diamond, Grosse Pointe, MI (US)

(73) Assignee: Ford Global Technologies, LLC, Dearborn, MI (US)

(21) Appl. No.: 17/223,040

(22) Filed: Apr. 6, 2021

(51) Int. Cl. B60K 31/16; B60W 40/09; B60W 40/105

(52) U.S. Cl. CPC B60K 31/16; B60W 40/09; B60W 40/105; B60K 2031/0091

(57) ABSTRACT

A computer includes a processor and a memory storing instructions executable by the processor to receive an input by a first user setting a maximum speed for a vehicle; prevent a second user from operating the vehicle above the maximum speed; permit the second user to operate the vehicle above the maximum speed upon at least one condition being met; in response to permitting the second user to operate the vehicle above the maximum speed, transmit a first collection of vehicle data to the first user; and in response to the second user failing to stop the vehicle at a stop indicator, transmit a second collection of the vehicle data to the first user.

### BACKGROUND

Some vehicles are equipped with speed limiters or governors. A speed limiter or governor regulates a speed of the vehicle in which it is installed, e.g., by regulating a speed of a propulsion such as an engine of the vehicle.

### BRIEF DESCRIPTION OF THE DRAWINGS

FIG. 1 is a block diagram of an example vehicle.

FIG. 2 is a process flow diagram of an example process for a first user to set a profile for a second user for when the second user is operating the vehicle.

FIGS. 3A and 3B are collectively a process flow diagram of an example process for controlling the vehicle when operated by the second user according to the profile of the second user.

### DETAILED DESCRIPTION

This disclosure provides techniques for limiting a speed of a vehicle while permitting driving above a maximum speed under certain conditions. The maximum speed can be set by a first user for when a second user is operating the vehicle. For example, the first user can be a parent, and the second user can be a child; or the first user can be a fleet manager, and the second user can be one of a plurality of vehicle operators for the fleet. In some situations, traveling above the maximum speed may be permissible, e.g., when completing a pass, when another vehicle is approaching quickly from behind, etc. The techniques herein limit the speed of the vehicle to the maximum speed as a default and provide the second user the ability to exceed the maximum speed when in situations in which a higher speed is permissible. Moreover, this disclosure provides techniques for efficiently providing data for the first user to monitor how the second user operates the vehicle. The techniques provide data about the operation of the vehicle in circumstances likely to be important to the first user. For example, this disclosure describes transmitting data about when the vehicle exceeds the maximum speed. For another example, this disclosure describes transmitting data about when the vehicle fails to fully stop at a stop indicator, e.g., a stop sign or traffic light illuminated red. By not providing data at other times, the vehicle reduces how much data is transmitted.

A computer includes a processor and a memory storing instructions executable by the processor to receive an input by a first user setting a maximum speed for a vehicle; prevent a second user from operating the vehicle above the maximum speed; permit the second user to operate the vehicle above the maximum speed upon at least one condition being met; in response to permitting the second user to operate the vehicle above the maximum speed, transmit a first collection of vehicle data to the first user; and in response to the second user failing to stop the vehicle at a stop indicator, transmit a second collection of the vehicle data to the first user.

The vehicle data may include time series data of at least one of vehicle speed, accelerator-pedal position, and brake status.

The vehicle data may include image data from at least one camera of the vehicle.

The vehicle data may include a configuration of a user interface of the vehicle.

The at least one condition may include that a duration that the vehicle exceeds the maximum speed is less than a threshold time. The threshold time may be based on vehicle speed.

The duration may be a duration that the vehicle continuously exceeds the maximum speed.

The duration may be a total duration that the vehicle exceeds the maximum speed since turning the vehicle on.

The at least one condition may include that a number of times that the vehicle exceeds the maximum speed is below a threshold number.

The at least one condition may include receiving an input from the second user other than pressing an accelerator pedal to a desired speed.

The maximum speed may vary with a speed limit of a location of the vehicle.

The maximum speed may be a first maximum speed, and the instructions may further include instructions to prevent the second user from operating the vehicle above a second maximum speed when the at least one condition is met, the second maximum speed being greater than the first maximum speed.

The input may be a first input, and the instructions may further include instructions to receive a second input by the first user selecting a configuration of a user interface of the vehicle, and configure the user interface according to the selected configuration when the second user is operating the vehicle.

The instructions may further include instructions to, in response to the second user failing to stop the vehicle at the stop indicator, actuate a user interface of the vehicle. Actuating the user interface may include outputting an alert to the second user.

Actuating the user interface may include disabling a feature of the user interface.

The instructions may further include instructions to, in response to detecting road users of a prespecified classification, decrease the maximum speed. The prespecified classification may include at least one of pedestrian or bicyclist.

The instructions may further include instructions to, in response to detecting road users of a prespecified classification, actuate a user interface of the vehicle.

A method includes receiving an input by a first user setting a maximum speed for a vehicle; preventing a second user from operating the vehicle above the maximum speed; permitting the second user to operate the vehicle above the maximum speed upon at least one condition being met; in response to permitting the second user to operate the vehicle above the maximum speed, transmitting a first collection of vehicle data to the first user; and in response to the second user failing to stop the vehicle at a stop indicator, transmitting a second collection of the vehicle data to the first user.

With reference to the Figures, wherein like numerals indicate like parts throughout the several views, a computer 102 includes a processor and a memory storing instructions executable by the processor to receive an input by a first user setting a maximum speed for a vehicle 100; prevent a second user from operating the vehicle 100 above the maximum speed; permit the second user to operate the vehicle 100 above the maximum speed upon at least one condition being met; in response to permitting the second user to operate the vehicle 100 above the maximum speed, transmit a first collection of vehicle data to the first user; and in response to the second user failing to stop the vehicle 100 at a stop indicator, transmit a second collection of the vehicle data to the first user.

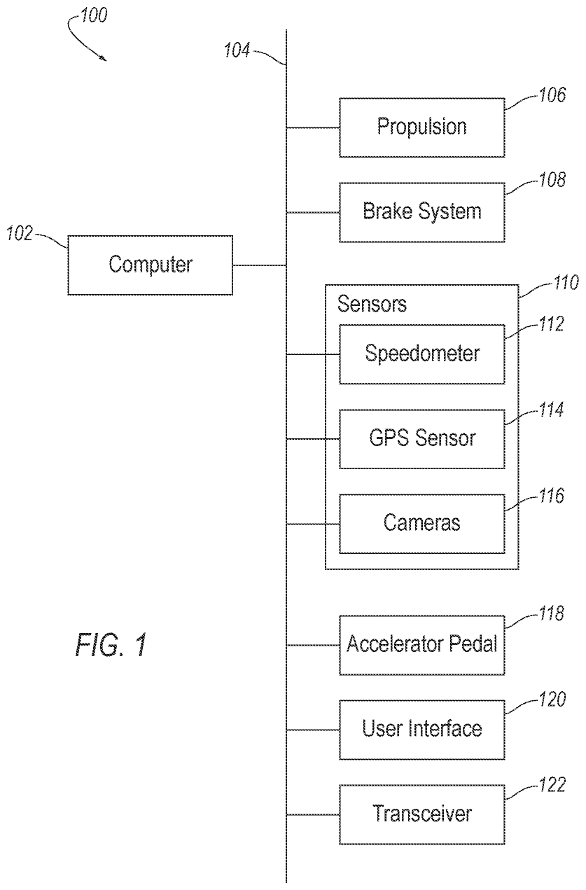

With reference to FIG. 1, the vehicle 100 may be any passenger or commercial automobile such as a car, a truck, a sport utility vehicle, a crossover, a van, a minivan, a taxi, a bus, etc.

The computer 102 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The computer 102 can thus include a processor, a memory, etc. The memory of the computer 102 can include media for storing instructions executable by the processor as well as for electronically storing data and/or databases, and/or the computer 102 can include structures such as the foregoing by which programming is provided. The computer 102 can be multiple computers coupled together.

The computer 102 may transmit and receive data through a communications network 104 such as a controller area network (CAN) bus, Ethernet, WiFi, Local Interconnect Network (LIN), onboard diagnostics connector (OBD-II), and/or by any other wired or wireless communications network. The computer 102 may be communicatively coupled to a propulsion 106; a brake system 108; sensors 110 including a speedometer 112, a GPS sensor 114, and cameras 116; an accelerator pedal 118; a user interface 120; a transceiver 122; and other components via the communications network 104.

The propulsion 106 of the vehicle 100 generates energy and translates the energy into motion of the vehicle 100. The propulsion 106 may be a conventional vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion. The propulsion 106 can include an electronic control unit (ECU) or the like that is in communication with and receives input from the computer 102 and/or a human operator. The human operator may control the propulsion 106 via, e.g., the accelerator pedal 118 and/or a gear-shift lever.

The brake system 108 is typically a conventional vehicle braking subsystem and resists the motion of the vehicle 100 to thereby slow and/or stop the vehicle 100. The brake system 108 may include friction brakes such as disc brakes, drum brakes, band brakes, etc.; regenerative brakes; any other suitable type of brakes; or a combination. The brake system 108 can include an electronic control unit (ECU) or the like that is in communication with and receives input from the computer 102 and/or a human operator. The human operator may control the brake system 108 via, e.g., a brake pedal.

The sensors 110 may provide data about operation of the vehicle 100, for example, wheel speed, wheel orientation, and engine and transmission data (e.g., temperature, fuel consumption, etc.). For example, the sensors 110 include the speedometer 112. The sensors 110 may detect the location and/or orientation of the vehicle 100. For example, the sensors 110 may include the global positioning system (GPS) sensor 114; accelerometers such as piezo-electric or microelectromechanical systems (MEMS); gyroscopes such as rate, ring laser, or fiber-optic gyroscopes; inertial measurements units (IMU); and magnetometers. The sensors 110 may detect the external world, e.g., objects and/or characteristics of surroundings of the vehicle 100, such as other vehicles, road lane markings, traffic lights and/or signs, pedestrians, etc. For example, the sensors 110 may include radar sensors, scanning laser range finders, light detection and ranging (LIDAR) devices, and the cameras 116.

The speedometer 112 may be any sensor suitable for measuring the speed of the vehicle 100, for example, as is known, a mechanical or eddy-current speedometer, or a vehicle speed sensor. A vehicle speed sensor may use a magnetic field detector to count interruptions of a magnetic field by a toothed metal disk disposed on a driveshaft of the propulsion 106 of the vehicle 100.

The GPS sensor 114 receives data from GPS satellites. The Global Positioning System (GPS) is a global navigation satellite system. The satellites broadcast time and geolocation data. The GPS sensor 114 can determine a location of the vehicle 100, i.e., latitude and longitude, based on receiving the time and geolocation data from multiple satellites simultaneously.

The cameras 116 can detect electromagnetic radiation in some range of wavelengths. For example, the cameras 116 may detect visible light, infrared radiation, ultraviolet light, or some range of wavelengths including visible, infrared, and/or ultraviolet light. For another example, the cameras 116 may be a time-of-flight (TOF) cameras, which include a modulated light source for illuminating the environment and detect both reflected light from the modulated light source and ambient light to sense reflectivity amplitudes and distances to the scene.

At least one of the cameras 116 has a field of view external to the vehicle 100. For example, at least one of the cameras 116 can be forward-facing and positioned at a front end of the vehicle 100 or behind the windshield. At least one of the cameras 116 has a field of view in a passenger cabin of the vehicle 100. For example, at least one of the cameras 116 can have a field of view encompassing an operator of the vehicle 100, e.g., a face of the operator.

The accelerator pedal 118 is depressible by a foot of the operator of the vehicle 100 to instruct the propulsion 106 to accelerate the vehicle 100. For example, the accelerator pedal 118 can be hinged. The accelerator pedal 118 can include a position sensor to detect a position of the accelerator pedal 118. The position sensor may be any sensor providing an output mapping onto a linear or rotational position of the accelerator pedal 118, e.g., a capacitive transducer, a capacitive displacement sensor, an eddy-current sensor, an ultrasonic sensor, a Hall effect sensor, an inductive noncontact position sensor, a piezoelectric transducer, a potentiometer, a proximity sensor, a linear or rotary coder, a string potentiometer, etc.

The user interface 120 presents information to and receives information from an occupant of the vehicle 100. The user interface 120 may be located, e.g., on an instrument panel in a passenger cabin of the vehicle 100, or wherever may be readily seen by the occupant. The user interface 120 may include dials, digital readouts, screens, a heads-up display, speakers, and so on for providing information to the occupant, e.g., human-machine interface (HMI) elements such as are known. The user interface 120 may include buttons, knobs, keypads, microphone, and so on for receiving information from the occupant.

The user interface 120 is configurable into different configuration, i.e., collections of values for settings that govern operation of the user interface 120. The settings can include a manner of conveying information or other output to the operator, e.g., media volume, screen brightness, choice of information being outputted such as whether a screen displays navigation instructions or media selections, etc. The configuration can include what information is being outputted to the operator, e.g., choice of media such as radio, audio input from a mobile device, navigation instructions, etc. The configuration can include which features of the user interface 120 are enabled or disabled. For example, the first user can select to disable a feature such as radio or media inputs from a mobile device when the second user is operating the vehicle 100.

The transceiver 122 may be adapted to transmit signals wirelessly through any suitable wireless communication protocol, such as cellular, Bluetooth®, Bluetooth® Low Energy (BLE), ultra-wideband (UWB), WiFi, IEEE 802.11a/b/g/p, cellular-V2X (CV2X), Dedicated Short-Range Communications (DSRC), other RF (radio frequency) communications, etc. The transceiver 122 may be adapted to communicate with a remote server, that is, a server distinct and spaced from the vehicle 100. The remote server may be located outside the vehicle 100. For example, the remote server may be associated with another vehicle (e.g., V2V communications), an infrastructure component (e.g., V2I communications), an emergency responder, a mobile device associated with the first user or the second user of the vehicle 100, etc. The transceiver 122 may be one device or may include a separate transmitter and receiver.

As described below, a first user can select a maximum speed, whereby a second user cannot operate the vehicle 100 above the maximum speed unless at least one condition is met. The first user can select a fixed value for the maximum speed, e.g., 70 miles per hour (mph). Alternatively or additionally, the user can select a maximum speed that varies with a speed limit of a location of the vehicle 100. For example, the maximum speed can be a posted speed limit of a road on which the vehicle 100 is traveling plus or minus a fixed value, e.g., for a fixed value of +5 mph, 30 mph for a posted speed limit of 25 mph, 70 mph for a posted speed limit of 65 mph, etc. For another example, the maximum speed can be the posted speed limit plus or minus a variable value, e.g., values selected for different posted speed limits such as +7 mph for a posted speed limit of 35 mph, +10 mph for a posted speed limit of 70 mph, etc. The value could be variable based on a weather forecast, e.g., +5 mph for dry conditions, —5 mph for wet conditions. The value could be variable based on a road type or road conditions, e.g., +5 mph for paved roads, +0 mph for gravel roads, etc., +10 mph for onramps, +5 mph for other road types, etc. Providing these different options permits the first user to select a maximum speed tailored for the second user.

When the first user has set the maximum speed, the second user can operate the vehicle 100 above the maximum speed when at least one condition is met. The condition can be that an amount for which the vehicle 100 has exceeded the maximum speed is below a threshold value. The amount for which the vehicle 100 has exceeded the maximum speed can be measured as a duration spent above the maximum speed, a number of times exceeding the maximum speed, etc. For example, the condition can be that a duration for which the vehicle 100 exceeds the maximum speed is less than a threshold time. The duration can be a duration that the vehicle 100 continuously exceeds the maximum speed, i.e., without falling below the maximum speed. The duration can be a total duration for which the vehicle 100 exceeds the maximum speed since turning the vehicle 100 on, i.e., over the course of a single trip. Both types of duration can be tracked, with a different threshold time applied to each. The threshold time is selectable by the first user. The threshold time can be a fixed value selected by the first user. The threshold time can be based on vehicle speed, e.g., on how much the vehicle 100 is exceeding the maximum speed, e.g., 30 seconds for up to 5 mph over the maximum speed, 10 seconds for more than 5 mph up to 10 mph over the maximum speed, 5 seconds for more than 10 mph up to 20 mph over the maximum speed, etc. For another example, the condition can be that a number of times that the vehicle 100 exceeds the maximum speed is below a threshold number. The speed of the vehicle 100 rising above the maximum speed and then falling below the maximum speed is one time exceeding the maximum speed. The number of times can be counted since turning the vehicle 100 on, i.e., over the course of a single trip, or counted over a previous fixed time period or fixed distance, e.g., 5 minutes or 5 miles. The threshold number is selectable by the first user.

Alternatively or additionally, the condition can be receiving an input from the second user other than pressing an accelerator pedal 118 to a desired speed. By requiring an additional input besides pushing the accelerator pedal 118 to control speed, the computer 102 helps ensure that the second user only exceeds the maximum speed intentionally, not by, e.g., inattentiveness toward the speed of the vehicle 100. The input can be chosen so that the second user is unlikely to provide the input when operating the vehicle 100 other than on purpose. For example, the input can be briefly pressing the accelerator pedal 118 to a fully depressed position and then pressing the accelerator pedal 118 to the desired speed. For another example, the input can be tapping the accelerator pedal 118 a number of times, e.g., twice, and then pressing the accelerator pedal 118 to the desired speed. For another example, the input can be making a selection to exceed the maximum speed via the user interface 120 while pressing the accelerator pedal 118 to the desired speed.

When the vehicle 100 exceeds the maximum speed, the computer 102 generates a first collection of vehicle data to transmit to the first user. The first collection can include vehicle data starting a time period before the vehicle 100 exceeded the maximum speed, e.g., 5 seconds before, to a time period after the vehicle 100 falls below the maximum speed, e.g., 2 seconds. The time periods can be chosen to be sufficiently long to cover likely causes of the second user operating the vehicle 100 above the maximum speed, such as to complete a pass. The vehicle data can include a current date. The vehicle data can include a location and/or a direction of travel of the vehicle 100, e.g., from the GPS sensor 114. The vehicle data can include time series data from the sensors 110 and/or other components of the vehicle 100. A “time series,” or “time series data,” is a set of data issued or recorded sequentially over time. The time series data can include vehicle speed, accelerator-pedal position, brake status, engine revolutions per minute (rpm), stability control data, etc. The accelerator-pedal position can be a position of the accelerator pedal 118, e.g., as a percentage of a maximum position, i.e., from undepressed (0%) to fully depressed (100%). The brake status can include, e.g., a braking force, whether an antilock brake system (ABS) is engaged, whether a service brake is engaged, etc. The stability control data can include whether an electronic stability control (ESC) system is engaged. The vehicle data can include image data from one or more of the cameras 116, including a camera 116 aimed externally to the vehicle 100 and/or a camera 116 aimed at the second user. The vehicle data can include weather data, e.g., received via the transceiver 122. The vehicle data can include the configuration of the user interface 120, as described above.

When the vehicle 100 fails to fully stop at a stop indicator, the computer 102 generates a second collection of vehicle data to transmit to the first user. For the purposes of this disclosure, a “stop indicator” is a traffic control signal that is instructing vehicles to stop, e.g., a stop sign, a traffic signal illuminated red, a flashing red light, etc. The second collection can include vehicle data starting a time period or distance of travel before passing by the stop indicator, e.g., 5 seconds or 10 meters, to a time period or distance of travel after passing by the stop indicator, e.g., 2 seconds or 5 meters. The time periods or distances of travel can be chosen to be sufficiently long to cover the circumstances of passing approaching and traveling through an intersection that includes the stop indicator. The vehicle data can include the same types of vehicle data as included in the first collection.

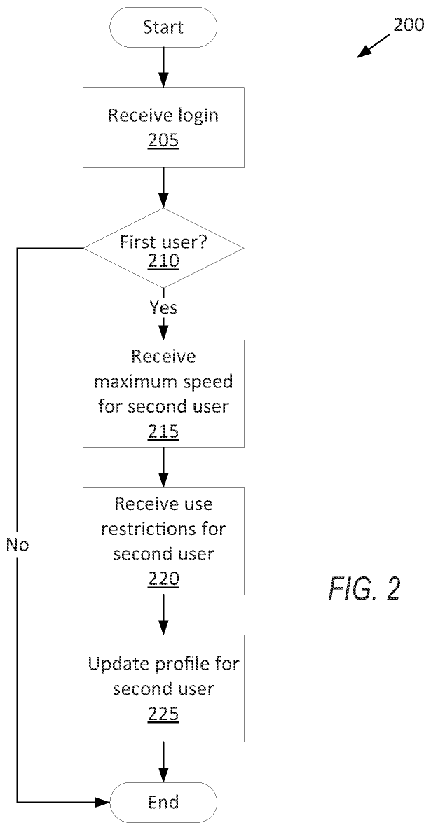

FIG. 2 is a process flow diagram illustrating an exemplary process 200 for the first user to set a profile for the second user for when the second user is operating the vehicle 100. The memory of the computer 102 stores executable instructions for performing the steps of the process 200 and/or programming can be implemented in structures such as mentioned above. As a general overview of the process 200, when the computer 102 receives a login by the first user, the computer 102 accepts inputs setting the maximum speed and selecting a configuration of the user interface 120. The computer 102 updates a profile of the second user with the maximum speed and the configuration of the user interface 120. Alternatively or additionally, the process 200 can be performed by a mobile device of the first user, and the mobile device can then transmit the updated profile of the second user to the computer 102, e.g., via the transceiver 122.

The process 200 begins in a block 205, in which the computer 102 receives data of the operator of the vehicle 100, e.g., image data from the cameras 116 showing the operator, or identifying data from the user interface 120.

Next, in a decision block 210, the computer 102 identifies whether the operator is the first user. For example, the operator can use a keyfob to start the vehicle 100, and the keyfob has an RFID tag or the like uniquely specifying the operator from among other potential operators who regularly use the vehicle 100. The RFID signal can be associated with the operator in memory. For another example, a mobile phone or device of the occupant can pair with, e.g., the user interface 120 of the vehicle 100. The mobile phone or device can be associated with the operator in memory. For another example, the computer 102 can use the data from the camera 116 having a field of view including a face of the operator and can identify the occupant using image-recognition techniques as are known. For another example, the operator can enter identifying information such as a username and password into the user interface 120. If the operator is the first user, the process 200 proceeds to a block 215. If the operator is not the first user, the process 200 ends. The second user thus cannot change their own profile.

In the block 215, the computer 102 receives a first input from the first user, e.g., via the user interface 120, setting the maximum speed, as described above. The first input can also include a quantity by which the maximum speed decreases when the vehicle 100 detects a road user of a prespecified classification, e.g., pedestrian or bicyclist. The decrease of the maximum speed can be a preset quantity, e.g., 10 mph, or a preset percentage, 10% of the maximum speed, according to the selection of the first user.

Next, in a block 220, the computer 102 receives a second input from the first user, e.g., via the user interface 120, selecting a configuration of the user interface 120 of the vehicle 100, as described above. For example, the second input can specify an audio feature, e.g., a maximum volume for radio or other media inputs. The selected configuration is applied to the user interface 120 when the second user is operating the vehicle 100, as described below with respect to a process 300. The second input may also select a configuration of the user interface 120 to be applied when the second user fails to fully stop as specified by a stop indicator, as described below with respect to a block 336 below. For example, the second input can specify a feature such as an audio feature, e.g., the radio or media input, to be disabled. The second input may also select a configuration of the user interface 120 to be applied when the vehicle 100 detects a road user of a prespecified classification, e.g., pedestrian or bicyclist. For example, the second input can specify a feature such as an audio feature, e.g., the radio or media input, to be disabled.

Next, in a block 225, the computer 102 stores the data from the first input and the second input in the profile for the second user. For the purposes of this disclosure, a “profile” is a collection of data associated with a specific person such as an operator of the vehicle 100. After the block 225, the process 200 ends.

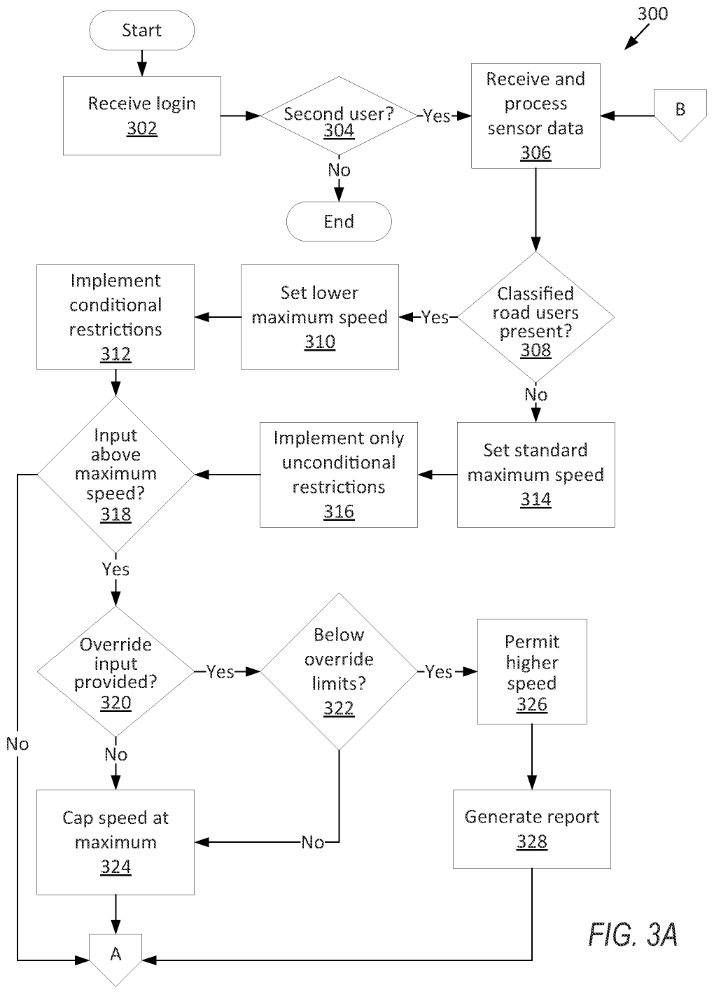

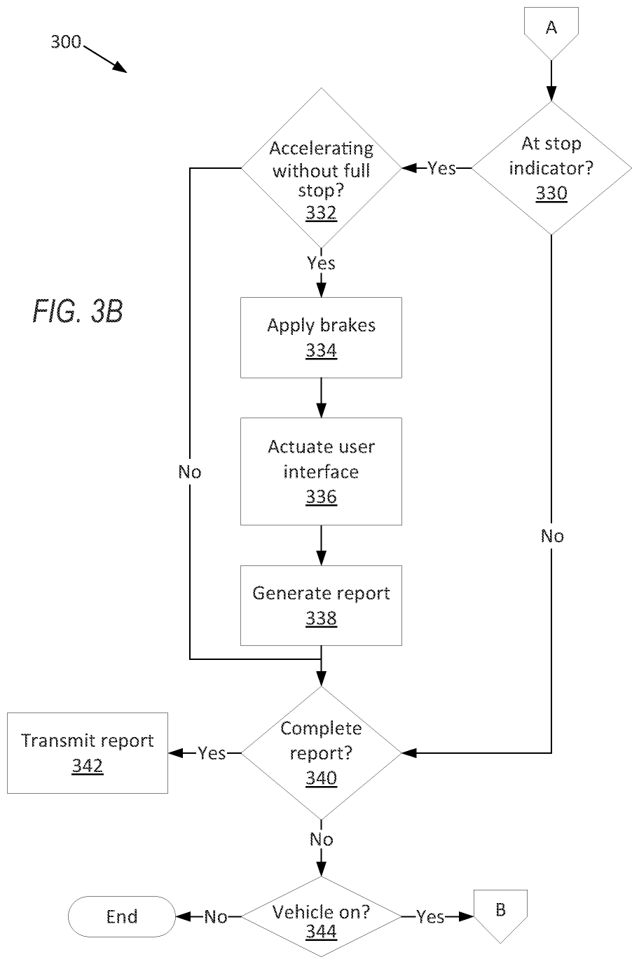

FIGS. 3A and 3B are collectively a process flow diagram illustrating an exemplary process 300 for controlling the vehicle 100 when operated by the second user according to the profile of the second user. The memory of the computer 102 stores executable instructions for performing the steps of the process 300 and/or programming can be implemented in structures such as mentioned above. As a general overview of the process 300, when the computer 102 receives a login by the first user, the computer 102 determines based on data from the sensors 110 whether any road users of a prespecified classification are present. If not, the computer 102 sets the maximum speed and the configuration of the user interface 120 according to the profile of the second user; if so, the computer 102 sets a lower maximum speed and additional restrictions on the user interface 120. If the second user requests a speed above the maximum speed, the computer 102 permits the higher speed and generates the vehicle data for the first collection if the condition is met. If the condition is not met, the computer 102 prevents the vehicle 100 from exceeding the maximum speed. If the vehicle 100 does not fully stop at a stop indicator, the computer 102 actuates the brake system 108, actuates the user interface 120, and generates the vehicle data to include in the second collection. If any vehicle data has been generated for the first or second collection, the computer 102 instructs the transceiver 122 to transmit the first or second collection to the first user. The process 300 continues for as long as the vehicle 100 remains on.

The process 300 begins in a block 302, in which the computer 102 receives data of the operator of the vehicle 100, e.g., image data from the cameras 116 showing the operator, or identifying data from the user interface 120.

Next, in a decision block 304, the computer 102 identifies whether the operator is the second user. For example, the operator can use a keyfob or the like to start the vehicle 100, and the keyfob has an RFID tag or the like uniquely specifying the operator from among other potential operators who regularly use the vehicle 100. The RFID signal can be associated with the operator in memory. For another example, a mobile phone or device of the occupant can pair with, e.g., the user interface 120 of the vehicle 100. The mobile phone or device can be associated with the operator in memory. For another example, the computer 102 can use the data from the camera 116 having a field of view including a face of the operator and can identify the occupant using image-recognition techniques as are known. For another example, the operator can enter identifying information such as a username and password into the user interface 120. If the operator is the second user, the process 300 proceeds to a block 306. If the operator is not the second user, the process 300 ends. The first user thus is not subject to the maximum speed and the configuration of the user interface 120 reserved for the second user.

In the block 306, the computer 102 receives data from the sensors 110. The data from the sensors 110 includes image data from the cameras 116, location data from the GPS sensor 114, and speed data from the speedometer 112. The computer 102 also receives the accelerator-pedal position from the accelerator pedal 118.

Next, in a decision block 308, the computer 102 detects whether road users of a prespecified classification are present. The prespecified classification is a type of the road user, i.e., a categorization of road user with which specified rules for operating the vehicle 100 are associated, e.g., specific speed limits can be associated with a type of road user. The prespecified classification is typically chosen to include road users warranting greater care in operating the vehicle 100 than other road users. For example, the prespecified classification can include pedestrians and/or bicyclists. The computer 102 can identify the road users using conventional image-recognition techniques, e.g., a convolutional neural network programmed to accept images as input and output an identified type of road user. A convolutional neural network includes a series of layers, with each layer using the previous layer as input. Each layer contains a plurality of neurons that receive as input data generated by a subset of the neurons of the previous layers and generate output that is sent to neurons in the next layer. Types of layers include convolutional layers, which compute a dot product of a weight and a small region of input data; pool layers, which perform a downsampling operation along spatial dimensions; and fully connected layers, which generate based on the output of all neurons of the previous layer. The final layer of the convolutional neural network generates a score for each potential type of road user, and the final output is the type of road user with the highest score. In response to the road user being the prespecified classification, e.g., a pedestrian or a bicyclist, the process 300 proceeds to a block 310. If the road user is not the prespecified classification, the process 300 proceeds to a block 314.

In the block 310, the computer 102 decreases the maximum speed, i.e., sets the maximum speed at a lower value than the default value stored in the profile for the second user, based on the profile of the second user, e.g., based on the selection made by the first user in the block 215 of the process 200 above.

Next, in a block 312, the computer 102 configures the user interface 120 according to the selected configuration in the profile for the second user for use when a road user of the prespecified classification is present, e.g., based on the selection made by the first user in the block 220 of the process 200 above. If the user interface 120 has a heads-up display, the computer 102 can instruct the user interface 120 to highlight the road user in the heads-up display, e.g., with a bounding box. After the block 312, the process 300 proceeds to a decision block 318.

In the block 314, the computer 102 sets the maximum speed at the default value set in the profile of the second user, e.g., based on the selection made by the first user in the block 215 of the process 200 above.

Next, in a block 316, the computer 102 configures the user interface 120 according to the selected configuration in the profile for the second user, e.g., based on the selection made by the first user in the block 220 of the process 200 above. After the block 316, the process 300 proceeds to the decision block 318.

In the decision block 318, the computer 102 determines whether the second user is requesting a speed above the maximum speed. The computer 102 can determine whether the acceleration corresponding to the accelerator-pedal position will increase (or maintain) the speed of the vehicle 100 above the maximum speed. If the acceleration would put the speed of the vehicle 100 above the maximum speed, the process 300 proceeds to a decision block 320. If the acceleration would leave the speed of the vehicle 100 below the maximum speed, the process 300 proceeds to a decision block 330.

In the decision block 320, the computer 102 determines whether the computer 102 is receiving the input from the second user representing an intention to exceed the maximum speed, i.e., the input other than pressing the accelerator pedal 118 to a desired speed, as described above. If the computer 102 is receiving the input, the process 300 proceeds to a decision block 322. If the computer 102 is not receiving the input, the process 300 proceeds to a block 324.

In the decision block 322, the computer 102 determines whether the amount by which the vehicle 100 has exceeded the maximum speed is below the threshold value, e.g., the duration is below the threshold time or the number of times is below the threshold number, as described above. If the amount is above the threshold value, the process 300 proceeds to the block 324. If the amount is below the threshold value, the process 300 proceeds to a block 326.

In the block 324, the computer 102 prevents the second user from operating the vehicle 100 above the maximum speed. For example, the computer 102 can instruct the propulsion 106 to operate at the maximum speed. After the block 324, the process 300 proceeds to the decision block 330.

In the block 326, the computer 102 permits the second user to operate the vehicle 100 above the maximum speed. The computer 102 can instruct the propulsion 106 to operate at the desired speed indicated by the accelerator-pedal position. The maximum speed may be a first maximum speed, and the computer 102 may prevent the second user from operating the vehicle 100 above a second maximum speed. The second maximum speed is greater than the first maximum speed. The second maximum speed can be selected by the first user for the profile of the second user. The computer 102 can instruct the propulsion 106 to operate at the second maximum speed if the accelerator-pedal position indicates a speed above the second maximum speed.

Next, in a block 328, the computer 102 generates the vehicle data to include in the first collection, as described above. After the block 328, the process 300 proceeds to the decision block 330.

In the decision block 330, the computer 102 determines whether the vehicle 100 is at a stop indicator. For example, the computer 102 can consult map data stored in memory using the location data from the GPS sensor 114 to determine whether a stop indicator is located at the location of the vehicle 100. For another example, the computer 102 can identify the stop indicator using conventional image-recognition techniques, e.g., a convolutional neural network programmed to accept images as input and output an identified type of traffic control signal, as described above with respect to road users in the decision block 308. In response to the computer 102 detecting a stop indicator, the process 300 proceeds to a decision block 332. In response to the computer 102 failing to detect a stop indicator, the process 300 proceeds to a decision block 340.

In the decision block 332, the computer 102 determines whether the second user is accelerating from the stop indicator after failing to fully stop the vehicle 100 at the stop indicator. For example, the computer 102 can determine that the speed data is increasing after not decreasing to zero (or to within a margin of error of zero). If the vehicle 100 is accelerating after not decreasing the speed to zero at the stop indicator, the process 300 proceeds to a block 334. If the speed of the vehicle 100 fully decreased to zero or is still decreasing, the process 300 proceeds to the decision block 340.

In the block 334, the computer 102 instructs the brake system 108 to brake the vehicle 100 until the speed is zero.

Next, in a block 336, the computer 102 actuates the user interface 120 to output an alert to the second user. The alert is at least one of audible, visual, or haptic. For example, the computer 102 can instruct the user interface 120 to display a message and/or symbol in the instrument cluster and/or to sound a beep or chime. The alert could additionally be haptic, e.g., vibrating a seat in which the operator is sitting. The computer 102 can also actuate the user interface 120 by configuring the user interface 120 according to the selected configuration in the profile for the second user for use when the vehicle 100 has failed to fully stop at a stop indicator.

Next, in a block 338, the computer 102 generates the vehicle data to include in the second collection, as described above. After the block 338, the process 300 proceeds to the decision block 340.

In the decision block 340, the computer 102 determines whether all the vehicle data has been generated that will be included in the first collection or second collection. For example, for the first collection, the computer 102 can determine whether the time period has elapsed since the speed of the vehicle 100 fell below the maximum speed, as described above. For the second collection, the computer 102 can determine whether the time period has elapsed or distance of travel has been traversed since the vehicle 100 passed the stop indicator, as described above. If all the vehicle data has been generated, the process 300 proceeds to a block 342. If no vehicle data has been generated or less than all the vehicle data has been generated, the process 300 proceeds to a decision block 344.

In the block 342, the computer 102 transmits the completed first or second collection to the first user. For example, the computer 102 can instruct the transceiver 122 to transmit the completed first or second collection. After the block 342, the process 300 proceeds to the decision block 344.

In the decision block 344, the computer 102 determines whether the vehicle 100 is still on. If the vehicle 100 is still on, the process 300 returns to the block 306 to continue monitoring the data from the sensors 110. If the vehicle 100 has been turned off, the process 300 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. Use of “in response to” and “upon determining” indicates a causal relationship, not merely a temporal relationship. The adjectives “first” and “second” are used throughout this document as identifiers and are not intended to signify importance, order, or quantity.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A computer comprising a processor and a memory storing instructions executable by the processor to:
receive an input by a first user setting a maximum speed for a vehicle;
prevent a second user from operating the vehicle above the maximum speed;
permit the second user to operate the vehicle above the maximum speed upon at least one condition being met;
in response to permitting the second user to operate the vehicle above the maximum speed, transmit a first collection of vehicle data to the first user; and
in response to the second user failing to stop the vehicle at a stop indicator, transmit a second collection of the vehicle data to the first user.

2. The computer of claim 1, wherein the vehicle data includes time series data of at least one of vehicle speed, accelerator-pedal position, and brake status.

3. The computer of claim 1, wherein the vehicle data includes image data from at least one camera of the vehicle.

4. The computer of claim 1, wherein the vehicle data includes a configuration of a user interface of the vehicle.

5. The computer of claim 1, wherein the at least one condition includes that a duration that the vehicle exceeds the maximum speed is less than a threshold time.

6. The computer of claim 5, wherein the threshold time is based on vehicle speed.

7. The computer of claim 5, wherein the duration is a duration that the vehicle continuously exceeds the maximum speed.

8. The computer of claim 5, wherein the duration is a total duration that the vehicle exceeds the maximum speed since turning the vehicle on.

9. The computer of claim 1, wherein the at least one condition includes that a number of times that the vehicle exceeds the maximum speed is below a threshold number.

10. The computer of claim 1, wherein the at least one condition includes receiving an input from the second user other than pressing an accelerator pedal to a desired speed.

11. The computer of claim 1, wherein the maximum speed varies with a speed limit of a location of the vehicle.

12. The computer of claim 1, wherein the maximum speed is a first maximum speed, and the instructions further include instructions to prevent the second user from operating the vehicle above a second maximum speed when the at least one condition is met, the second maximum speed being greater than the first maximum speed.

13. The computer of claim 1, wherein the input is a first input, and the instructions further include instructions to receive a second input by the first user selecting a configuration of a user interface of the vehicle, and configure the user interface according to the selected configuration when the second user is operating the vehicle.

14. The computer of claim 1, wherein the instructions further include instructions to, in response to the second user failing to stop the vehicle at the stop indicator, actuate a user interface of the vehicle.

15. The computer of claim 14, wherein actuating the user interface includes outputting an alert to the second user.

16. The computer of claim 14, wherein actuating the user interface includes disabling a feature of the user interface.

17. The computer of claim 1, wherein the instructions further include instructions to, in response to detecting road users of a prespecified classification, decrease the maximum speed.

18. The computer of claim 17, wherein the prespecified classification includes at least one of pedestrian or bicyclist.

19. The computer of claim 1, wherein the instructions further include instructions to, in response to detecting road users of a prespecified classification, actuate a user interface of the vehicle.

20. A method comprising:
receiving an input by a first user setting a maximum speed for a vehicle;
preventing a second user from operating the vehicle above the maximum speed;
permitting the second user to operate the vehicle above the maximum speed upon at least one condition being met;
in response to permitting the second user to operate the vehicle above the maximum speed, transmitting a first collection of vehicle data to the first user; and
in response to the second user failing to stop the vehicle at a stop indicator, transmitting a second collection of the vehicle data to the first user.
